(19) United States
(12) Patent Application Publication
(10) Pub. No.: US 2014/0167393 A1
(43) Pub. Date: Jun. 19, 2014

(54) FOLDABLE STROLLER FRAME HAVING THREE SECTIONS JOINED TO AND FOLDABLE AROUND A COMMON HUB STRUCTURE

(71) Applicant: Baby Trend Inc., Ontario, CA (US)

(72) Inventors: Denny Tsai, Chino Hills, CA (US); Jung Tsai CHEN, Tainan (TW); Derek Conrad, Ontario, CA (US)

(73) Assignee: Baby Trend Inc., Ontario, CA (US)

(21) Appl. No.: 14/010,470

(22) Filed: Aug. 26, 2013

Related U.S. Application Data
(63) Continuation-in-part of application No. 13/241,082, filed on Sep. 22, 2011, now Pat. No. 8,517,412.

(51) Int. Cl. B62B 7/06

(52) U.S. Cl. CPC B62B 7/06
USPC 280/650

(57) ABSTRACT

A foldable stroller frame has three sections (a lower-front section, a lower-rear section, and an upper-rear section) joined to and foldable around a common hub structure. The hub structure includes two hubs located on the left and right sides of the stroller frame. The lower-rear section is attached to a pair of brackets of the hub and the other two sections are attached to two guide plates of the hub, to allow the three sections to rotate with respect to each other when the stroller is folded and unfolded. The hub also includes a releasable locking structure for locking the stroller frame in the unfolded state. A release trigger, including a release lever located on a horizontal section extending between the two rear wheels of the stroller, and a wire coupling the release lever and the locking structure, for releasing the locking structure to allow the frame to fold.

This application is a continuation-in-part application under 35 USC §120 of U.S. patent application Ser. No. 13/241082, filed Sep. 22, 2011, now U.S. Pat. No. 8,517,412, issued Aug. 27, 2013, which is herein incorporated by reference in its entirety.

### BACKGROUND OF THE INVENTION

1. Field of the Invention

This invention relates to a foldable baby stroller, and in particular, it relates to a foldable baby stroller frame having three sections that are joined to and foldable around a common hub structure.

2. Description of the Related Art

Numerous foldable baby stroller designs have been patented and implemented which allow a stroller to be folded or collapsed into a compact shape for storage or transportation.

### SUMMARY OF THE INVENTION

The present invention is directed to a foldable stroller that allows easy folding and provides a compact folded shape.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, the present invention provides a foldable stroller frame which includes: a lower-front section; a lower-rear section; an upper-rear section having an end section forming a push handle of the stroller; and a hub structure, wherein the lower-front section, the lower-rear section and the upper-rear section are joined to the hub structure and are foldable with respect to one another around the hub structure, wherein the hub structure includes a first gear and a second gear, the first gear being fixedly attached to one of the lower-front section, the lower-rear section and the upper-rear section, the second gear being fixedly attached to another one of the lower-front section, the lower-rear section and the upper-rear section, and the first and second gear being engaged with each other and rotating when the stroller frame changes between an unfolded state and a folded state, the hub structure further including a releasable locking structure for preventing the lower-front section, the lower-rear section and the upper-rear section from folding with respect to one another around the hub structure, wherein the stroller frame further comprises a pull trigger connected to the releasable locking structure by a wire for releasing the locking structure to allow the lower-front section, the lower-rear section and the upper-rear section to fold with respect to one another around the hub structure.

In another aspect, the present invention provides a foldable stroller frame which includes: a lower-front section; a lower-rear section; two rear wheels attached to the lower-rear section; a horizontal section extending between the two rear wheels; an upper-rear section having an end section forming a push handle of the stroller; a hub structure, wherein the lower-front section, the lower-rear section and the upper-rear section are joined to the hub structure and are foldable with respect to one another around the hub structure, wherein the hub structure includes a pair of brackets fixedly attached to an end portion of the lower-rear section, a first guide plate fixedly attached to an end portion of the lower-front section, and a second guide plate fixedly attached to an end portion of the upper-rear section, the first and second guide plates rotating with respect to the brackets when the stroller frame changes between an unfolded state and a folded state, the hub structure further including a releasable locking structure for preventing the first and second guide plates from rotating with respect to the brackets; and a release trigger structure, including a release lever located on the horizontal section extending between the two rear wheels, and a wire coupling the release lever to the locking structure, for releasing the locking structure to allow the first and second guide plates to rotate with respect to the brackets.

It is to be understood that both the foregoing general description and the following detailed description are exemplary and explanatory and are intended to provide further explanation of the invention as claimed.

### BRIEF DESCRIPTION OF THE DRAWINGS

FIGS. 1 and 2 are perspective and side views, respectively, of a foldable stroller frame according to a first embodiment of the present invention.

FIGS. 3 and 4 illustrate the foldable stroller frame of FIG. 1 in a partially folded and a folded state, respectively.

FIG. 5 is an exploded view of a hub of the stroller frame of FIG. 1.

FIGS. 6-8 are partial cut-away views showing the assembled hub when the stroller frame of FIG. 1 is in an unfolded, partially folded and folded state, respectively.

FIG. 9 is an exploded view showing a release trigger structure for a lock of the hub of FIG. 5.

FIG. 10 is an exploded view of a hub of a foldable stroller frame according to a second embodiment of the present invention.

FIG. 10A shows a portion of the hub structure of FIG. 10.

FIGS. 11 and 12 illustrate the unfolded and folded states of the hub structure of FIG. 10.

FIGS. 13 and 14 illustrate a locking release mechanism of the second embodiment.

### DETAILED DESCRIPTION OF THE PREFERRED EMBODIMENTS

Embodiments of the present invention provide a foldable stroller, where the stroller frame has three sections that are joined to, and foldable around, a common hub structure to fold the stroller into a compact shape.

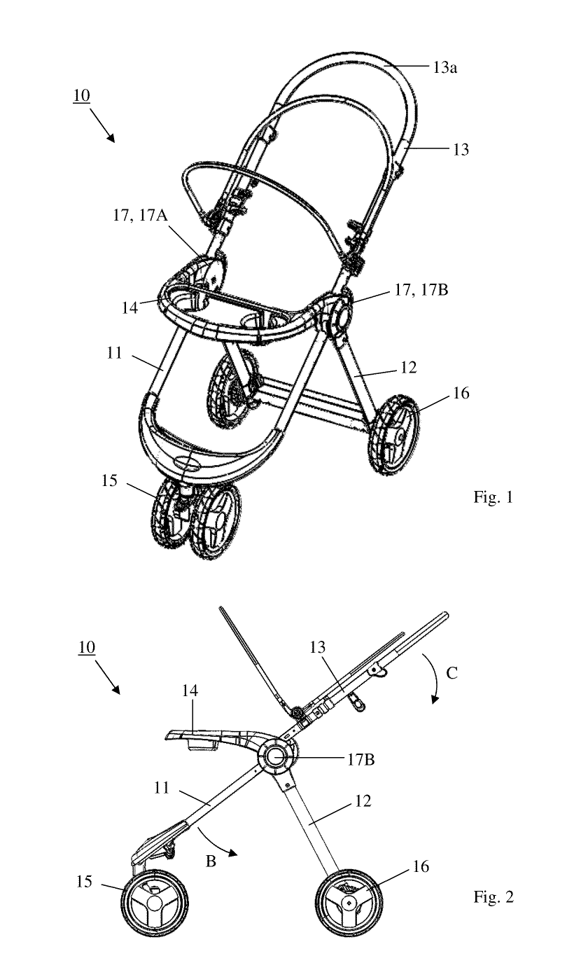

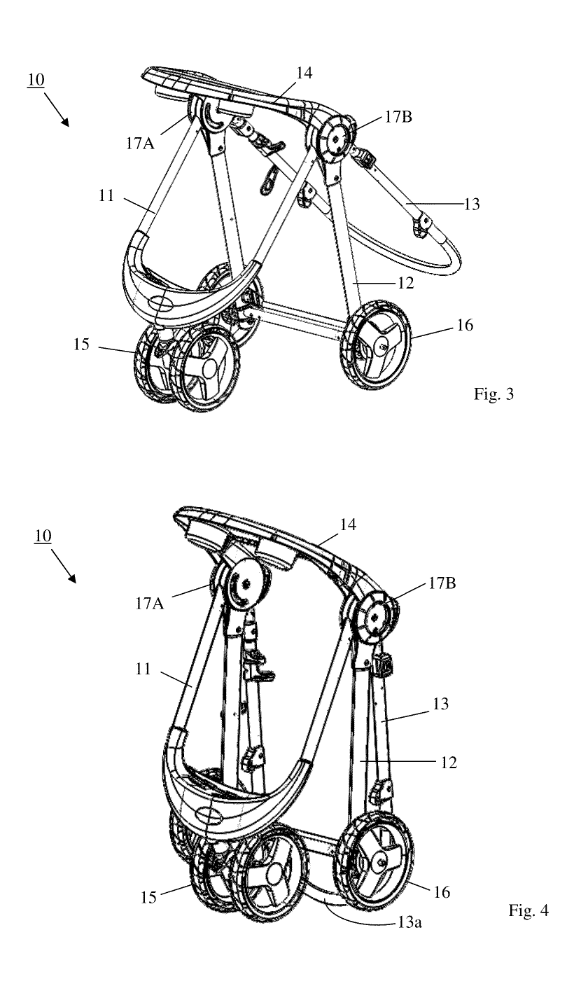

FIGS. 1 and 2 are perspective and side views, respectively, of a foldable stroller frame according to a first embodiment of the present invention. FIGS. 3 and 4 illustrate the foldable stroller frame in a partially folded and a folded state, respectively.

As shown in FIGS. 1 and 2, the stroller frame 10 includes three frame sections: a lower-front section 11, a lower-rear section 12, and an upper-rear section 13. One or more front wheels 15 are mounted on the lower-front section 11, and two rear wheels 16 are mounted on the lower-rear section 12. The upper-most portion 13a of the upper-rear section 13 functions as a push handle of the stroller. The three frame sections 11, 12 and 13 are joined to a hub structure 17, which is located at a location that is substantially the center of the stroller frame in both the front-to-back direction and top-to-bottom direction (see FIG. 2).

In the illustrated embodiment, each of the frame sections 11, 12 and 13 has a pair of bars located on the left and right sides, respectively, of the stroller frame 10. While the two bars in each pair of bars shown in FIG. 1 are substantially parallel to each other, they may also be non-parallel. The space between each pair of bars is empty, forming an empty interior space between the bars, in which a child seat is located. The child seat (not shown in the drawings) is made of a flexible material such as a fabric material, and is attached to various parts of the frame sections 11, 12, and 13 by suitable means such as stitching, strapping, etc. A tray 14 may be optionally provided. In the illustrated embodiment, the tray 14 is attached to the hub structure 17, but the tray may also be attached to only the lower-front section 11 or the only the upper-rear section 13. The tray 14 may be openable or removable for easy ingress/egress of the child.

Preferably, each of the three frame sections 11, 12 and 13 has an overall shape that is substantially planar, as best seen in the side view (FIG. 2). Non-planar shapes may also be used, as long as they do not significantly interfere with folding as will be described later. For example, the shape of the frame section 11 (or 12, or 13) may be slightly curved in the side view.

The three frame sections 11, 12 and 13 are joined to the hub structure 17 so that they are foldable relative to one another by swinging motions around the hub structure, as shown in FIGS. 2, 3 and 4. When the stroller frame 10 is in an unfolded state, shown in FIGS. 1 and 2, the lower-front section 11 extends from the hub structure 17 to a lower-front location of the stroller; the lower-rear section 12 extends from the hub structure to a lower-rear location; and the upper-rear section 13 extends from the hub structure to an upper-rear location. To fold the stroller frame 10, the lower-front section 11 swings around the hub 17 backwards toward the lower-rear section 12 as indicated by the arrow B in FIG. 2; the upper-rear section 13 swings around the hub downwards toward the lower-rear section 12 as indicated by the arrow C. Note that while the lower-rear section 12 is used as a reference position in the above description, this section 12 does not have to be stationary; the movements of the three sections are relative to one another.

In the folded state, shown in FIG. 4, the front wheels 15, the rear wheels 16 and the push handle 13a are located in close proximity of one another. In this manner, the folded stroller frame 10 has a compact shape.

In the illustrated embodiment, the hub structure 17 includes two parts 17A and 17B on the two sides (left and right) of the stroller frame 10. For convenience, in this disclosure, each part is referred to as a hub and they are collectively referred to as the hub structure. The hubs 17A and 17B each have a compact shape. In a preferred embodiment, each hub is less than a few inches in size in a side view of the stroller.

A locking structure is preferably provided to lock the three sections 11, 12 and 13, i.e. to prevent them from swinging relative to one another, when the stroller is in the unfolded state. The locking structure is releasable to allow folding of the stroller frame. Any suitable locking structure may be used.

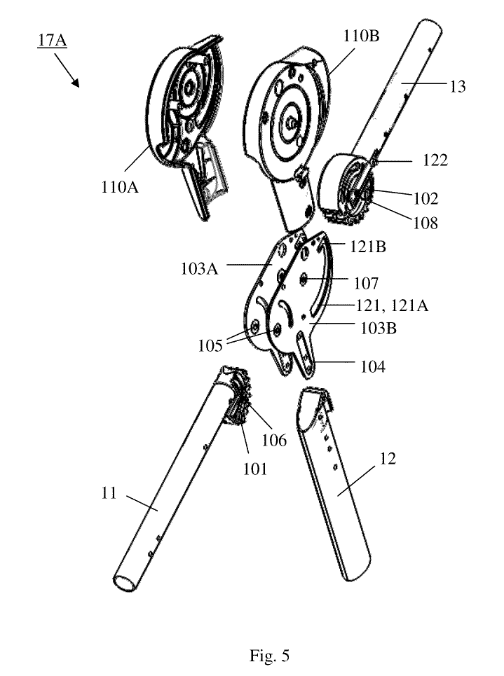

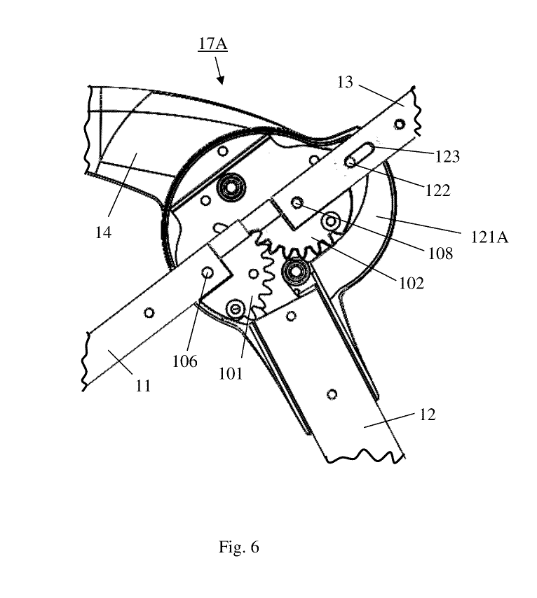

FIGS. 5-9 illustrate a mechanism that may be employed for either the left-side hub 17A or the right-side hub 17B or both of the stroller frame of FIGS. 1-4. The left-side hub 17A is used as an example here. FIG. 5 is an exploded view of the hub 17A and how it is joined to the three frame sections 11, 12 and 13. FIGS. 6-8 are partial cut-away views showing the assembled hub 17A when the stroller frame 10 is in an unfolded, partially folded and folded state, respectively. In these drawings, the frame sections 11, 12 and 13 are only represented by an end segment of each bar constituting the frame sections.

As shown in FIGS. 5-8, the hub 17A includes a first teethed member (gear) 101 fixedly attached to an end of the lower-front bar 11, and a second teethed member (gear) 102 fixedly attached to an end of the upper-rear bar 13. The first and second gears 101, 102 are engaged with each other when the hub 17A is assembled (FIG. 6-8). A bracket structure includes two plate-shaped brackets 103A, 103B disposed in parallel such that they sandwich the gears 101 and 102 between them. Each bracket has an elongated attachment portion 104 for fixedly attaching the bracket to the end of the lower-rear bar 12, which is sandwiched between the two elongated portions 104. Covers 110A, 110B are disposed on both sides of the hub 17A to cover the gears 101, 102, the brackets 103A, 103B, and an end portion of each bar 11, 12, 13.

Each bracket 130A, 130B has a first hole 105, into which a center pin (rotation shaft) 106 of the first gear 101 is inserted, such that the gear 101 (along with the lower-front bar 11) rotates around an axis defined by the holes 105. Each bracket 130A, 130B also has a second hole 107, into which a center pin (rotation shaft) 108 of the second gear 102 is inserted, such that the gear 103 (along with the upper-rear bar 13) rotates around an axis defined by the holes 107. As shown in FIGS. 6-8, the locations of the holes 105, 106 and the sizes of the gears 101, 102 are such that the teeth of the gears 101 and 102 are engaged with each other in the assembled state. As a result, the two gears 101 and 102 rotate in synchrony, so that the bars 11 and 13 swing toward or away from the lower-rear section 12 in synchrony (i.e. the lower-front section 11 and the upper-rear section 13 do not swing independently). Thus, if the user pushes the upper-rear section 13 toward the lower-rear section 12 to fold the stroller frame, the lower front section 11 will rotate toward the lower-rear section 12 by means of the gear action, without having to be pushed by the user.

As can be seen from FIGS. 5-8, due to the design of the hub 17A, the lower-front section 11 and the upper-rear section 13 do not rotate around the same rotation axis, but their respective rotation axes are both located within the hub 17A and are in close proximity of each other.

The hub 17A is provided with a releasable locking mechanism for locking the three sections 11, 12 and 13 in the unfolded state. The releasable locking mechanism includes a curved guiding slot 121 provided on each bracket 103A, 103B, and a locking pin 122 slidably disposed on the upper-rear bar 13 near the gear 102. In the assembled state, the locking pin 122 is inserted into the guiding slots 121 of the bracket 103A, 103B. As the frame sections 11, 12 and 13 swing with respect to one another when the stroller frame is being folded/unfolded, the pin 122 slides along the guiding slots 121 (see FIGS. 6-8).

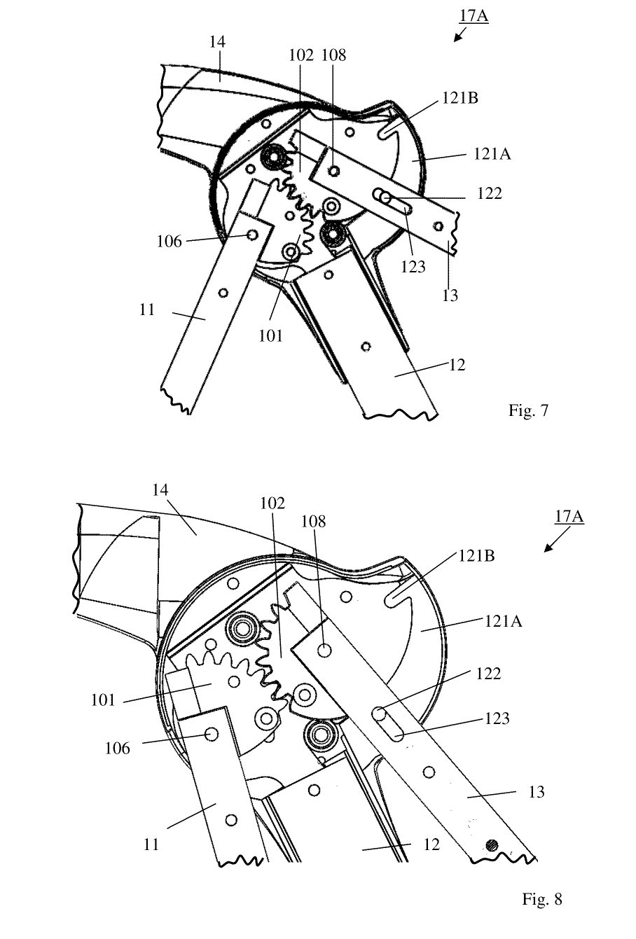

As shown in FIGS. 5-8, each guiding slot 121 has an arc-shaped first part 121A and a substantially radially disposed second part 121B at one end of the first part 121A. (Both the arc and the radial direction are defined with respect to the rotation axis 107.) The pin 122 is slidable along the upper-rear bar 13 within a slot 123 that is elongated in a direction parallel to the upper-rear bar 13. The pin 122 is biased by a biasing member (e.g. a spring) 124 toward the rotation shaft 108 (see FIG. 9, exploded view of a part of the upper-rear section 13 and hub 17A). When the upper-rear section 13 is swung to the fully unfolded position (FIG. 6), the pin 122 slides in the first parts 121A of the guiding slots 121 to the point where the second parts 121B joins the first parts 121A. At this point, the pin 122 slides along the elongated slot 123 into the second parts 121B of the guiding slots 121 under the urge of the spring 124. In this position, the pin 122 is prevented from sliding along the first parts 121A of the guiding slot, so that the upper-rear section 13 is locked with respect to the lower-rear section 12. The lower-front section 11 is also locked by means of the gears 101 and 102.

To release the lock, a release wire 125 is provided inside the upper-rear bar 13 to connect the pin 122 to a pull trigger 126 located on the upper-rear bar 13, preferably just below the push handle 13a for convenience. When the user pulls the pull trigger 126, the wire 125 is pulled to overcome the biasing force of the spring 124, causing the pin 122 to retreat (along the elongated slot 123) out of the second parts 121B of the guiding slots 121. At this point, if the user pushes the upper-rear section 13 to swing it toward the lower-rear section 12, the pin 122 can now slide along the first parts 121A of the guiding slots 121. In lieu of the release wire 125 and the pull trigger 126, other suitable structures may be used to manually overcome the biasing force of the spring 124 to release the lock.

As any position along the first part 121A, the locking pin 122 will be biased by the spring 124 against the inner edge of the slot 121. This inner edge is not necessarily an arc shape centered at the hole 107 (the rotation axis of the gear 102). In the embodiment shown in FIGS. 5-8, the inner edge of the first part 121A is farther away from the hole 107 at the end where the first part 121A joins the second part 121B, and closer to the hole 107 at the other end of the first part 121A.

To summarize, the guiding slots 121, the pin 122, the spring 124, the release wire 125 and the pull tab 125 form a releasable locking mechanism. The pin 122 and the guiding slots 121 cooperates with each other to lock the swinging movement of the upper-rear section 13; the release wire 125 and the pull tab 125 operate to release the lock.

In the embodiment of FIG. 5 both brackets 103A and 103B are shown to have the guiding slots 121, and the pin 122 protrudes from both sides of the bar 13 to fit into the two guiding slots. In and alternative embodiment, the pin 122 protrudes from only one side of the bar 13, and only one of the brackets 103A and 103B on the side of the pins is required to have the guiding slots 121.

In an alternative embodiment, the locking pin 122 is located on the first gear 101, and the spring 124, the wire 125 and the release trigger 126 are correspondingly located in the lower-front bar 11. This embodiment is less convenient to the user.

In a preferred embodiment, the two hubs 17A and 17B have symmetrical structures, except that it is not necessary to provide a locking mechanism for both hubs 17A and 17B. In other words, a locking mechanism in either hub is sufficient to lock the stroller frame 10. In alternative embodiments, the two hubs may have different structures. For example, the hub 17B may omit the mating gears 101 and 102. When the two hubs have different structures, the main requirement is that they collectively define a rotation axis for the lower-front section and a rotation axis for the lower-rear section in the assembled state.

In the illustrated embodiments, the hub 17A is fixedly mounted on the lower-rear bar 12, and the lower-front bar 11 and the upper-rear bar 13 have gears mounted on them to rotate in synchrony. Alternatively, either the lower-front bar 11 or the upper-rear bar 13 may be fixed with respect to the hub and the other two bars may rotate.

Preferably, the tray 14 is rotatably mounted on the hubs 17A and 17B by a suitable mounting structure.

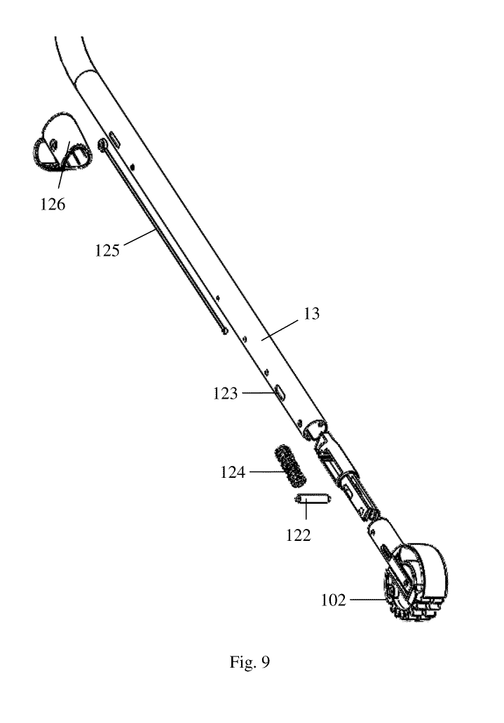

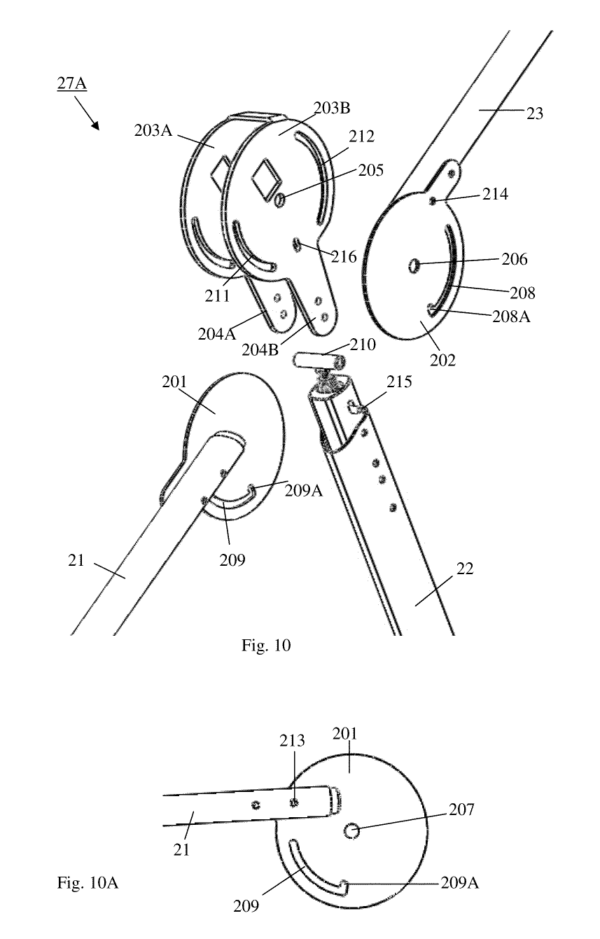

A foldable stroller frame according to a second embodiment of the present invention is described with reference to FIGS. 10-14. The foldable stroller frame of the second embodiment is similar to the first embodiment except for the following: the structure of the hub structure, and the location and structure of the release trigger. The way the stroller is folded is also different due to the location of the release trigger.

FIG. 10 is an exploded view of the structure of the left-side hub 27A of the second embodiment, corresponding to the hub 17A of the first embodiment. Parts of the lower-front section 21, lower-rear section 22, and upper-rear section 23 of the stroller frame are shown. The hub 27A includes two generally round plate-shaped brackets 203A, 203B disposed in parallel. Each bracket has an elongated attachment portion 204A, 204B, respectively, for fixedly attaching the bracket to the end of the lower-rear section 22, which is sandwiched between the two elongated portions 204A and 204B. Each bracket 203A, 203B has a center hole 205. The upper-rear section 23 has a guide plate 202 attached to its end, the guide plate having a generally round shape with a center hole 206 and a generally arc-shaped guide slot 208. Similarly, the lower-front section 21 has a generally round-shaped guide plate 201 with a center hole 207 (see FIG. 10A) and a generally arc-shaped guide slot 209.

When assembled, a center pin (rotation shaft) 210 located at the end of the lower-rear section 22 is inserted into the center holes 205 of the brackets 203A, 203B and the center holes 206, 207 of the guide plates 201, 202, and the attachment portions 204A, 204B of the brackets 203A, 203B are fixedly attached to an end portion of the lower-rear section 22. As a result, the sections 21, 22 and 23 can rotate with respect to each other around the rotation axis defined by the rotation shaft 210 and the center holes 205, 206, 207. An end portion of each of sections 21, 22 and 23, as well as the guide plates 201 and 202, are disposed inside the space created between the two brackets 203A, 203B. In this example, the guide plate 202 of the upper-rear section 23 is located closer to the inside bracket 203B, and the guide plate 201 of the lower-front section 21 is located closer to the outside bracket 203A.

Optionally, structures can be provided to create a desirable amount of friction between the guide plate 202 and the bracket 203B, and/or between the guide plate 201 and the bracket 203A, and/or between the guide plates 102 and 202. For example, a flat piece of suitable material such as plastic, fabric, etc. may be affixed on the face of the bracket 203B facing the plate 202 (i.e. facing away from the viewer in the view of FIG. 10), and/or a flat piece of suitable material may be fixed on the face of the plate 202 facing the bracket 203 (i.e. facing the viewer in the view of FIG. 10). The flat material(s) create a friction on the contact surface to slow down the relative rotation between the bracket 203B and the guide plate 202. Alternatively, the bracket 203B and the guide plate 202 themselves may be made of a suitable material that creates friction when they are in contact with each other. Similar structures may be provided between the guide plate 201 and the bracket 203A. Alternatively or at the same time, a suitable piece of material may be provided in the space between the plates 201 and 202. A washer or nut or other suitable structure may be provided on the center pin 210 to press the bracket 203B and plate 202 against each other to maintain the friction. Similar structures may be provided to press the bracket 203A and plate 201 against each other. The purpose of the friction between the bracket 203B and plate 202 is to prevent the upper-rear section 23 from falling under gravity during the folding process, as will be described in more detail later.

In addition, each bracket 203A, 203B has two arc-shaped guide slots 211, 212 located in peripheral areas, and guide plates 201, 202 respectively have guide pins 213, 214 located at their peripheral locations. When assembled, the guide pins 213, 214 are inserted into the respective guide slots 211, 212. These structures are optional but helps stabilize the rotation of the guide plates 201, 202 with respect to the brackets 203A, 203B.

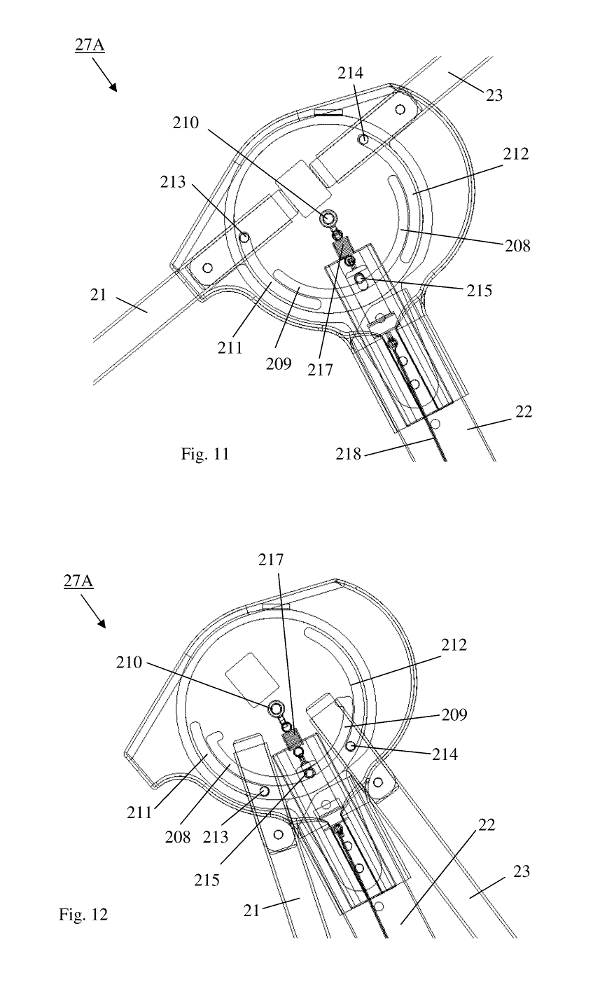

FIGS. 11 and 12 show the hub structure 27A in the unfolded and folded states, corresponding to the unfolded and folded states of the frame similar to those shown in FIGS. 1 and 4. Note that these two figures are illustrated in a “see-through” manner, where features are drawn even though they are behind other structures.

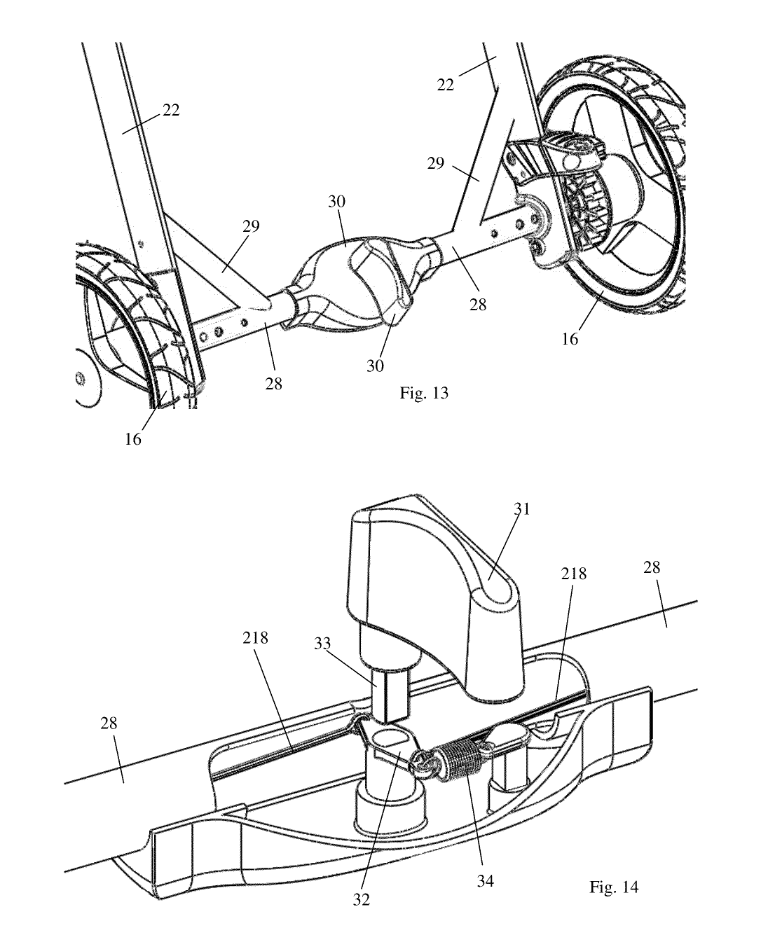

A locking structure is provided for releaseably locking the relative rotation of the three sections 21, 22 and 23. The locking structure includes a locking pin 215 located on the end portion of the lower-rear section 22, an elongated guide slot 216 on each bracket 203A, 203B, the arc-shaped guide slots 209 and 208 on the guide plates 201 and 202, respectively, and a pin release mechanism shown in more detail in FIGS. 13 and 14.

The locking pin 215 protrudes from both sides of the end portion of the lower-rear section 22 and can move along the longitudinal direction of the lower-rear section 22. When assembled, the locking pin 215 is inserted into the guide slots 216 on the bracket 203A, 203B and the guide slots 209, 208 on the respective guide plates 201, 202. The guide slot 216 is elongated in the radial direction to allow the locking pin 215 a range of movement in the radial direction with respect to the rotation axis 210 (which is the same as the longitudinal direction of the lower-rear section 22). The arc-shaped guide slots 209, 208 each has a hook portion 209A, 208A, respectively, which is disposed in a radial direction extending from one end of the arc-shaped slot toward the rotation axis. When the stroller frame is in the unfolded state, as shown in FIG. 11, the hook portions 209A, 208A are aligned with the elongated guide slot 216. In this state, the locking pin 215 is biased by a spring 217 to move in the radial direction toward the rotation axis, along the guide slot 216 and the hook portions 209A, 208A. The spring 217 is disposed inside the lower-rear section 22 and located between the locking pin 215 and the center pin 210 (see FIGS. 11, 12), and pulls the locking pin 215 toward the rotation center. Other kinds of biasing member may be used in lieu of the spring 217 as long as it biases the locking pin 215 toward the rotation axis. When the locking pin is located in the hook portion 209A and 208A under the biasing force of the spring 217, the guide plates 201, 202 are prevented from rotating, thereby locking the lower-front section 21 and upper-rear section 23 relative to the lower-rear section 22.

To release the lock, a wire 218 is provided inside the lower-rear section 22 and connected to the locking pin 215 to pull the locking pin 215 in a direction away from the rotation axis. As shown in FIGS. 13 and 14, the wire 218 extends inside the lower-rear section 22 to a horizontal section 28 of the frame that extends between the two rear wheels 16. A release mechanism 30 is provided on the horizontal section 28.

As shown in the partial cut-away and partial exploded view of FIG. 14, the end of the wire is attached to a twisting member 32. A release lever 31 is coupled to the twisting member 32 via a shaft 33 which has a non-circular shaped cross-section. When the release lever 31 is twisted by the user, in the clockwise direction in this example, the twisting member 32 twists and pulls the wire 218. This in turn causes the locking pin 215 to be pulled in the direction away from the rotation axis 210 and out of the hook portions 209A, 208A of the guide slots 209, 208 of the guide plates 201, 202 (see FIGS. 11, 12). As a result, the rotation of the guide plates 201, 202 is no longer prevented by the locking pin; the guide plates 201, 202 can now rotate while the locking pin 215 slides along the arc shaped portion of the guide slots 209, 208.

A spring 34 or other biasing member is coupled to the twisting member 32 to bias the twisting member in a direction opposite to the pulling direction of the wire 218 (counter-clockwise direction in this example). Thus, when the release lever 31 is not twisted by the user, the biasing spring 34 relaxes the pulling force on the wire 218. This biasing spring 34 is optional because, as described earlier, the biasing spring 217 in the hub structure already exerts a force on the locking pin 215 in the direction toward the rotation axis 210.

The release lever 31 is disposed outside of the horizontal section 28 and accessible to the user. In use, to fold the stroller frame, the user pushes the release lever 31, in the clockwise direction in this example, the wire 218 pulls the pin 215 out of the hook portions 209A, 208A of the guide slots 209, 208 of the guide plates 201, 202. Preferably, the release lever 31 is large enough for the user to push it with a foot. The user can then push the push handle (see 13a of FIG. 1) of the stroller to drop the upper-rear section 23 by a desirable amount. As mentioned earlier, a friction mechanism is preferably provided in the hub structure 27A such that the upper-rear section 23 does not fall down under gravity. The locking pin 215 is now located in the arc-shaped section of the guide slot 208. The user can then walk to a side of the stroller, then lift up the frame slightly so that the lower-front section 21, the lower-rear section 22 and the upper-rear section 23 can drop toward each other by gravity, while the locking pin 215 slides along the arc-shaped section of the guide slots 208 and 209. The stroller frame is now in a closed state.

As shown in FIG. 13, a straight or curved corner section 29 may be provided near where the lower-rear section 22 joins the horizontal section 28 of the frame, so that the wire 218 may run from the lower-rear section 22 through the corner section 29 to the horizontal section 28. This avoids a near 90 degree turn for the wire 218 and makes the pulling action smoother.

It will be apparent to those skilled in the art that various modification and variations can be made in the foldable stroller frame of the present invention without departing from the spirit or scope of the invention. Thus, it is intended that the present invention cover modifications and variations that come within the scope of the appended claims and their equivalents.

What is claimed is:

1. A foldable stroller frame comprising:
a lower-front section;
a lower-rear section;
an upper-rear section having an end section forming a push handle of the stroller; and
a hub structure,
wherein the lower-front section, the lower-rear section and the upper-rear section are joined to the hub structure and are foldable with respect to one another around the hub structure,
wherein the hub structure includes a first gear and a second gear, the first gear being fixedly attached to one of the lower-front section, the lower-rear section and the upper-rear section, the second gear being fixedly attached to another one of the lower-front section, the lower-rear section and the upper-rear section, and the first and second gear being engaged with each other and rotating when the stroller frame changes between an unfolded state and a folded state, the hub structure further including a releasable locking structure for preventing the lower-front section, the lower-rear section and the upper-rear section from folding with respect to one another around the hub structure,
wherein the stroller frame further comprises a pull trigger connected to the releasable locking structure by a wire for releasing the locking structure to allow the lower-front section, the lower-rear section and the upper-rear section to fold with respect to one another around the hub structure.

2. A foldable stroller frame comprising:
a lower-front section;
a lower-rear section;
two rear wheels attached to the lower-rear section;
a horizontal section extending between the two rear wheels;
an upper-rear section having an end section forming a push handle of the stroller;
a hub structure,
wherein the lower-front section, the lower-rear section and the upper-rear section are joined to the hub structure and are foldable with respect to one another around the hub structure,
wherein the hub structure includes a pair of brackets fixedly attached to an end portion of the lower-rear section, a first guide plate fixedly attached to an end portion of the lower-front section, and a second guide plate fixedly attached to an end portion of the upper-rear section, the first and second guide plates rotating with respect to the brackets when the stroller frame changes between an unfolded state and a folded state, the hub structure further including a releasable locking structure for preventing the first and second guide plates from rotating with respect to the brackets; and
a release trigger structure, including a release lever located on the horizontal section extending between the two rear wheels, and a wire coupling the release lever to the locking structure, for releasing the locking structure to allow the first and second guide plates to rotate with respect to the brackets.
